(19) United States
(12) Patent Application Publication
(10) Pub. No.: US 2002/0170441 A1
(43) Pub. Date: Nov. 21, 2002

(54) Maturation process for wines

(76) Inventor: Bryce A. Ecklein, Seattle, WA (US)

Correspondence Address: Bryce Ecklein, 2612 1st Ave. W., Seattle, WA, 98119, US

(21) Appl. No.: 10/074,925

(22) Filed: May 16, 2002

Related U.S. Application Data
(63) Continuation-in-part of application No. 09/225,229, filed on Jan. 4, 1999, now Pat. No. 6,378,419.

(51) Int. Cl. A23L 1/00

(52) U.S. Cl. 99/485

(57) ABSTRACT

A supportive addition to reference application Ser. No. 09/225,229 where alternative air distribution devices are used to connect multiple bores in cored oak slabs used for the aging of wine. Example configurations are shown including manifolds, air loops or air caps, all of suitable food grade materials. The disclosure also describes a voided out oak slab which does not rely on bores to bring air to the interior of the oak slab and an oak slab that has transverse slots to increase oak surface in contact with wine.

Preferred Configuration

The present invention provides for supportive additions to an invention covered by a prior application (Reference Ser. No. 09/225,229). The present invention provides alternative means for distributing air between cored air passages in the oak slabs of the prior and related invention and discloses alternatives to the formation of the oak slabs through the provision of a continuous internal void or transverse air channels. Example configurations are presented which accomplish the purpose of providing air exchange from one bore to another in a cored oak slab containing multiple bores.

Primary Alternative

The device in its preferred configuration consists of a manifold of food grade neoprene or other suitable food grade material that inner connects all air passages within the oak slabs and provides an air intake and air exit portal. Distribution ports on the manifold connect directly with cored passages in the oak slab and are sealed with food grade sealant and/or neoprene grommet sleeves. A single neoprene tube connects from the available air intake portal on the manifold and penetrates the containing vessel lid for air intake and another neoprene tube connects to the available air exit portal on the manifold and penetrates the containing vessel lid for air outflow. A positive air pressure is applied to the air intake tube and may contain pure oxygen or oxygen enriched air to aid oxidation.

Alternative Configuration “A”

An alternative configuration is identified for connecting the cored passages in the oak slabs. Instead of using the manifold as described in the primary alternative, individual air loop connectors can be employed to link adjacent bores together. The air loops can be made from neoprene, food grade plastic, stainless steel or other suitable food grade material and are sized to fit into cored passages. Sealing of the air loops with the oak slab would be accomplished with food grade caulking or neoprene grommets.

Alternative Configuration “B”

An alternative configuration is identified for connecting the cored passages in the oak slabs. Instead of using the manifold as described in the primary alternative, a continuous air cap can be employed across each face of the slab where the bores enter and exit the slab. This air cap would function in a similar manner to the manifold but would not directly connect to each bore, instead it would encompass all bores on one face of the slab. The air cap would contain an air intake port and an air exit port. The air cap would be cast from food grade plastic, stainless steel or other suitable food grade material. Sealing of the air cap with the oak slab would be accomplished with food grade caulking or neoprene gaskets.

Alternative Configuration “C”

An alternative configuration is identified for fabrication of the oak slabs wherein the surface area of the slabs is increased by introducing transverse slots through the oak slab on each side of each bore. These slots are cut through to within one inch of each face where the bores enter and exit the oak. Either the manifold cap or those identified in Alternative Configurations “A” or “B” can be used for air innerchange between bores.

Alternative Configuration “D”

An alternative configuration is identified for introducing air inside of the oak slabs wherein a portion of the internal volume of the oak slab is removed to provide a completely hollowed out void. A continuous air cap (as in Alternative Configuration “B”) is placed over the open portion of the slab created by extraction of the internal oak.

### DETAILED DESCRIPTION

Further understanding of the disclosure presented herein is described in drawings referenced as:

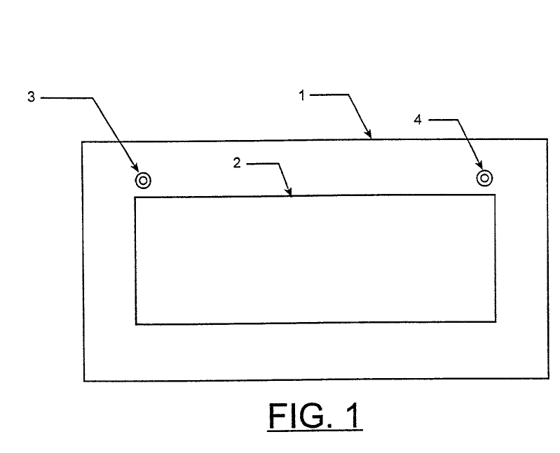

FIG. 1—Plan view of typical rectangular aging vessel showing removable airtight lid and air inlet and outlet ports.

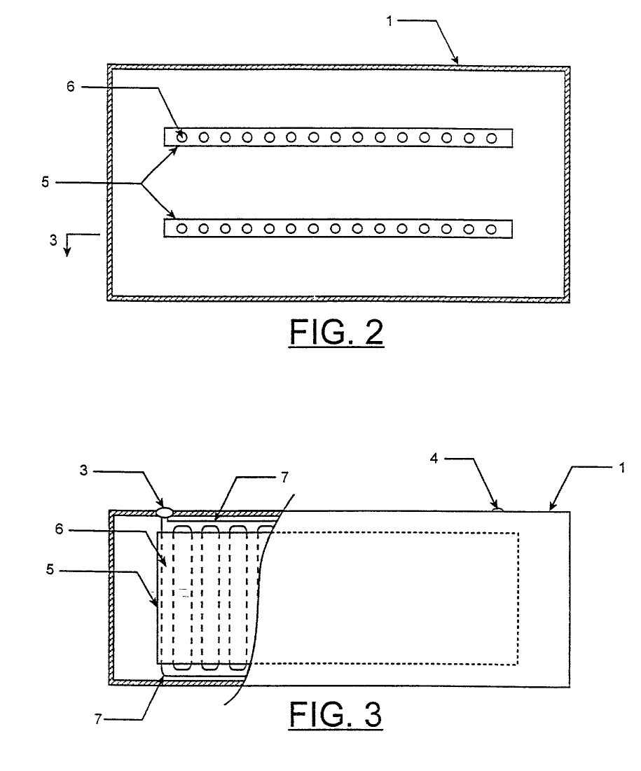

FIG. 2—Plan view of preferred embodiment showing airtight lid removed revealing cored oak slabs in rectangular aging vessel.

FIG. 3—Cut-away elevation view of typical rectangular aging vessel showing example arrangement of oak slab.

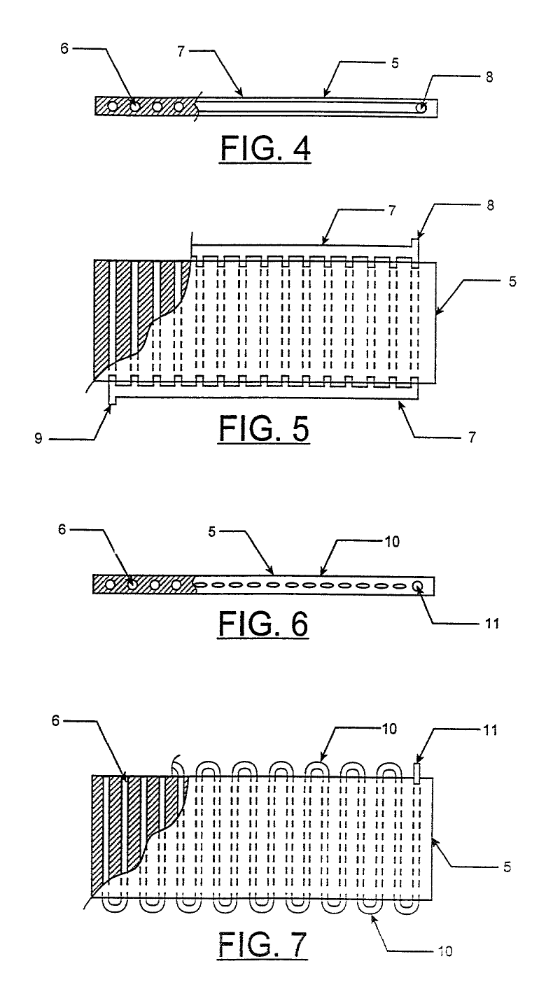

FIG. 4—Cut-away plan view of typical cored oak slab as in the preferred embodiment.

FIG. 5—Cut-away elevation view of typical cored oak slab as in preferred embodiment.

FIG. 6—Cut-away plan view of Alternative Configuration “A” air loops.

FIG. 7—Cut-away elevation of Alternative Configuration “A” air loops.

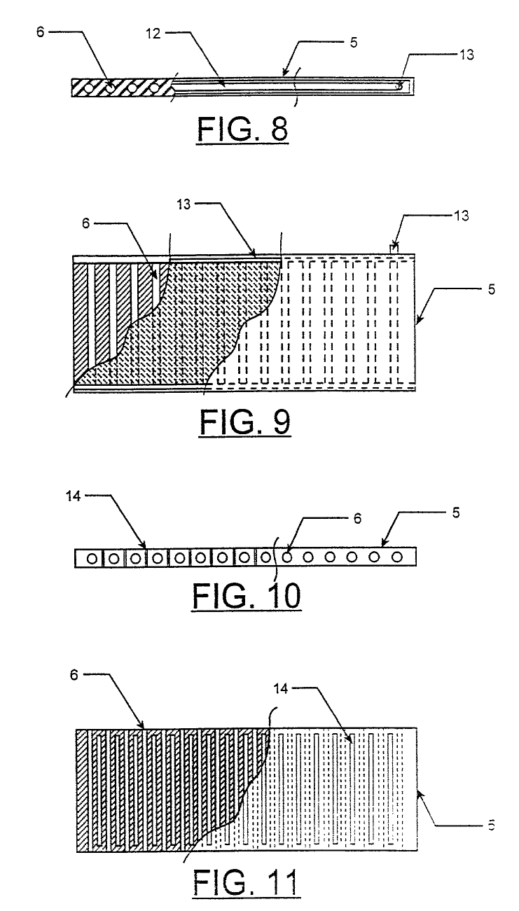

FIG. 8—Cut-away plan of Alternative Configuration “B” air cap.

FIG. 9—Cut-away side elevation view of Alternative Configuration “B” air cap.

FIG. 10—Cut-away plan of Alternative Configuration “C” transverse slot oak slab.

FIG. 11—Cut-away elevation of Alternative Configuration “C” transverse oak slab.

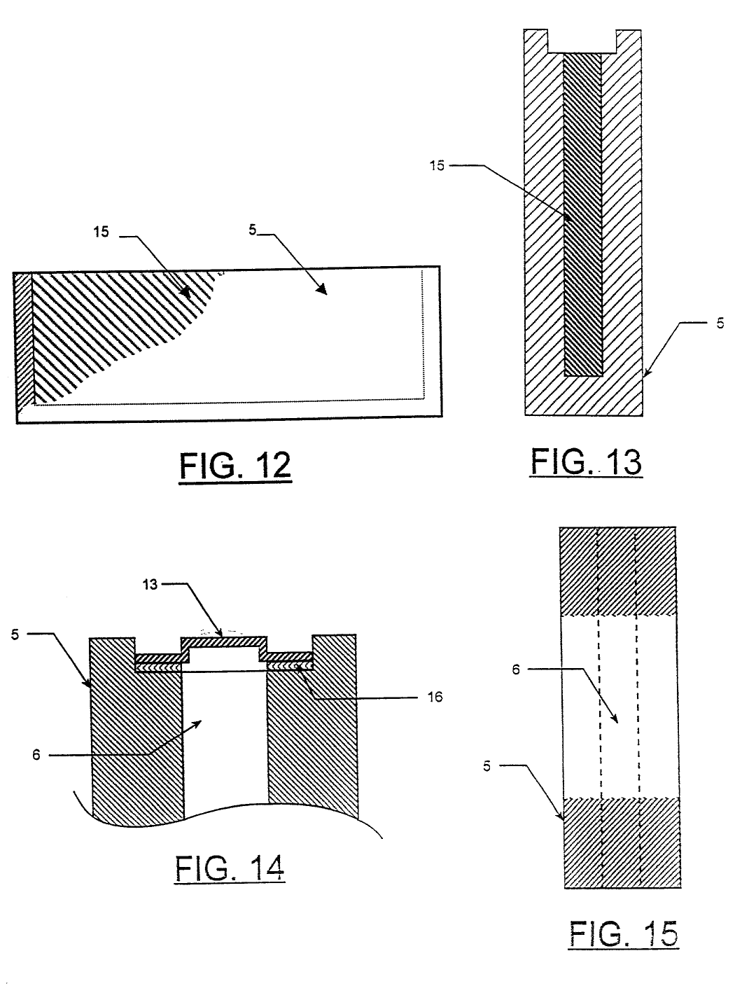

FIG. 12—Cut-away side elevation of Alternative Configuration “D” hollowed oak slab.

FIG. 13—End-on cross-section of Alternative Configuration “D” hollowed oak slab.

FIG. 14—End-on detail of Alternative Configuration “B”

FIG. 15—End-on cross-section detail of Alternative Configuration “C”

FIG. 1 discloses in plan view the preferred configuration rectangular aging vessel 1 with removable airtight lid 2 and air intake port 3 and air outlet port 4.

FIG. 2 indicates a plan view of the above mentioned containing vessel 1 showing the oak slabs 5 and bores 6. The number and spacing of oak slabs can be varied to match volume of the containing vessel and type of wine being aged.

FIG. 3 discloses in cross-sectional elevation view of the preferred configuration for utilizing oak slabs in the wine aging process. As shown, the rectangular containing vessel 1 is fitted internally with a through-cored oak slab 5. The oak slab is up to one and one half inches thick and contains a 0.375 inch to 0.5 inch bore 6. A manifold air innerchange 7 is connected to the bores in the oak slab and also to the air intake port 3 and air exit port 4.

FIG. 4 indicates a cut-away plan view of the preferred configuration manifold 7 with air exit port 8 in relation to the oak slab 5 and bores 6.

FIG. 5 indicates a cut-away elevation view of the preferred configuration manifolds 7 with air exit port 8 and air intake port 9 in relation to the oak slab 5 and bores 6.

FIG. 6 indicates a cut-away plan view of Alternative Configuration “A” air loops 10 with an air exit port 11 in relation to the oak slab 5 and bores 6.

FIG. 7 indicates a cut-away elevation view of Alternative Configuration “A” air loops 10 with an air exit port 11 in relation to the oak slab 5 and bores 6.

FIG. 8 indicates a cut-away plan view of Alternative Configuration “B” air cap 12 with an air exit port 13 in relation to the oak slab 5 and bores 6.

FIG. 9 indicates a cut-away elevation view of Alternative Configuration “B” air cap 12 with an air exit port 13 in relation to the oak slab 5 and bores 6.

FIG. 10 indicates a cut-away plan view of Alternative Configuration “C” transverse slot 14 in relation to the oak slab 5 and bores 6.

FIG. 11 indicates a cut-away elevation view of Alternative Configuration “C” transverse slot 14 in relation to the oak slab 5 and bores 6.

FIG. 12 indicates a cut-away elevation view of Alternative Configuration “D” voided interior 15 in relation to the oak slab 5.

FIG. 13 indicates an end-on cross-section detail of Alternative Configuration “D” internal void 15 in relation to the oak slab 5.

FIG. 14 indicates end-on cross-section detail of Alternative Configuration “B” air cap 13 and sealant 16 in relation to oak slab 5 and bores 6.

FIG. 15 indicates end-on cross-section detail of Alternative Configuration “C” transverse slot 14 in relation to oak slab 5 and bores 6.

1. A device to pneumatically innerconnect multiple air passages in cored oak slabs used for maturing wine comprised of
a. Impermeable food grade material and
b. Air intake and air exit ports to allow connection from one said oak slab to another or to an external air environment and
c. A method of sealing said device to said oak slab comprised of a food grade sealant or neoprene grommet.

2. The device in claim 1 where said pneumatic innerconnect is accomplished by a cast neoprene manifold with ports aligned to match said cores in said oak slabs.

3. The device in claim 1 where said pneumatic innerconnect is accomplished by air loops constructed of cast neoprene, plastic or stainless steel and connected from one said core to another said cores in said oak slabs.

4. The device in claim 1 where said pneumatic innerconnect is accomplished by an air cap constructed of cast neoprene or plastic and placed over said oak cores in said oak slabs.

5. A method for increasing wine/air contact in said oak slabs comprised of transverse slots cut through said oak slabs between said cores.

6. A method for introducing air inside said oak slabs comprised of voided out interior volume of said oak slabs.
